(19) United States
(12) Patent Application Publication
(10) Pub. No.: US 2024/0164364 A1
(43) Pub. Date: May 23, 2024

(54) COMBINATION CONTAINER AND INSECT REPELLANT

(71) Applicant: Allen F. Smithson, Mission Viejo, CA (US)

(72) Inventor: Allen F. Smithson, Mission Viejo, CA (US)

(21) Appl. No.: 17/991,304

(22) Filed: Nov. 21, 2022

(51) Int. Cl. A01M 29/12

(52) U.S. Cl. CPC A01M 29/12

(57) ABSTRACT

A flexible container in which to carry a natural insect repellant such as, for example, sawdust made from cedar wood that will emit a fragrance or aroma known to repel insects. The flexible container has tiny perforations formed therein through which the insect repellant is dispensed in response to it being shaken or squeezed. The container has a male snap at one end thereof and a female snap receptacle at the opposite end. The male snap of a first container is detachably connected to the female snap receptacle of a second container by which the first and second containers are connected together. In this manner, a plurality of insect repelling containers can be connected end-to-end to create a chain to be stretched or folded to fit an area or worn by an individual to be protected from both flying and crawling insects.

### BACKGROUND OF THE INVENTION

### 1. Field of the Invention

This invention relates to a flexible container that is filled with a natural insect repellant (e.g., sawdust made from cedar wood) that emits a fragrance or aroma that is known to repel insects. The flexible container has tiny perforations woven or formed therein through which the insect repellant is dispensed in response to the container being shaken or squeezed. A plurality of the insect repelling containers may be connected end-to-end, one to another to form a chain that can be stretched or folded into configurations that are suitable to fit inside a suitcase, laid under the cover of a bed, or wrapped around the body of a user who will spend time out of doors in an insect infested area.

### 2. Background Art

Insect infestation is a problem facing residents of apartments and houses in big cities and rural areas. For example, bed bugs have found their way into bedrooms and hidden themselves within the bedding. During the night, bed bugs are known to bite unsuspecting individuals while sleeping so as to leave the individuals with unsightly and annoying bite marks.

Common techniques for ridding an area of undesirable insects include spraying an insecticide, releasing a fog, and laying trays. In these cases, the insect-repelling means often contains toxic chemicals and/or a poison. Thus, one sleeping in an area that has been repeatedly treated over time may find himself or herself in a potentially hazardous environment that could be especially inhospitable to small children and pets. In the case of bed bugs, an exterminator sometimes needs to be summoned to use one or a variety of pesticides which tends to be expensive and may also expose the individual to an unhealthy environment while sleeping in his/her bedroom.

What is therefore desirable is an alternative to the conventional use of bug killing chemicals, poisons and the toxicity associated therewith. In particular, what would be preferable is a safe and natural (i.e., green) material which repels rather than kills insects and is suitable for use at locations where clothing is stored or transported and in an individual's bedding both inside and out of doors.

### SUMMARY OF THE INVENTION

Disclosed below is a flexible container that is filled with a non-toxic natural (i.e., green) material capable of emitting a fragrance or aroma that is known to repel insects. By way of example, the natural material with which the container is filled is sawdust made from cedar wood. The flexible container has tiny perforations woven or formed therein through which the insect repellant is released in response to the container being shaken or squeezed. The insect repellant that is released from the flexible container can be spread over an area to be protected from both flying and crawling insects.

A male snap is located at one end of the container and a female snap receptacle is located at the opposite end. By virtue of the foregoing, the male snap ofa first container is detachably connected to the female snap receptacle of a second container by which the first and second containers are connected together. In this manner, a plurality of insect repelling containers can be connected end-to-end and one to another in order to create a flexible chain to be stretched or folded so as to have a configuration suitable to fit into a suitcase, laid between a bed sheet and a bed cover, or wrapped around the body of a user who will spend time out of doors in an area that may be infested with insects.

### BRIEF DESCRIPTION OF THE DRAWINGS

FIG. 1 shows a perforated container in which to carry a solid non-toxic insect repellant to be dispensed from the container to cover an area in need of being protected from insects;

FIG. 2 shows a pair of the insect repelling containers of FIG. 1 being connected end-to-end and one to another;

FIG. 3 shows a plurality of the insect repelling containers connected together to form a flexible chain that is rolled up upon itself;

FIG. 4 shows the flexible chain of FIG. 3 formed by the plurality of insect repelling containers after being folded to fit into a suitcase;

FIG. 5 shows the flexible chain of FIG. 3 formed by the plurality of insect repelling containers after being stretched out to lay between a bed sheet and a bed cover; and

FIG. 6 shows the flexible chain of FIG. 3 sized to various lengths to be wrapped around the body of an individual who will spend time out of doors in an insect infested area.

### DESCRIPTION OF THE PREFERRED EMBODIMENT

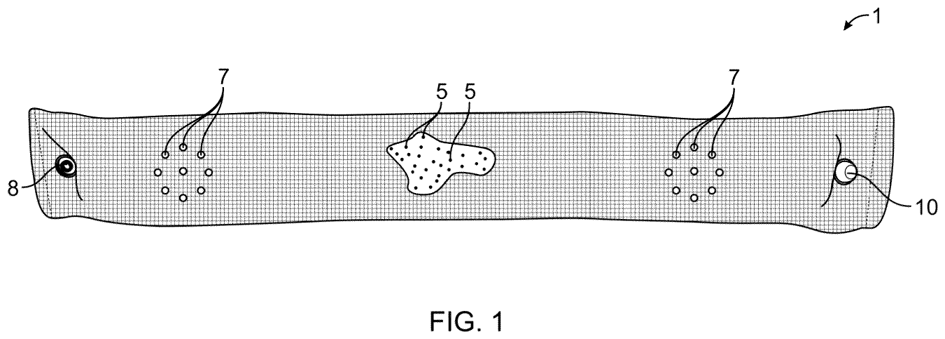

Referring initially to FIG. 1 of the drawings, there is shown a flexible lightweight container 1 in which to carry a solid, non-toxic insect repellant 5 that is known to drive insects away from a location at which the container is deployed. In accordance with a preferred embodiment of this invention, the container 1 has an elongated tubular configuration and a length of about 12 inches. However, it is to be understood that the particular shape and size of the container 1 in which the insect repellant 5 is carried is not to be considered a limitation of this invention.

By way of a preferred example, the insect repellant 5 is a natural, chemical free solid material such as, for example, cedar wood that has been ground into fine sawdust to be packaged within the container 1. However, any other aromatic material that will emit a pheromone or a similar fragrance capable of triggering a response in insects can be substituted for cedar.

The material from which the insect repelling container 1 is made is soft so that the container is capable of being compressed in response to the weight of a user or a squeezing force applied by a user. By way of example, a suitable material within which to pack the aromatic sawdust is cotton, such as that referred to as shop rag or that known commercially as Terrycloth. The container 1 is woven to be provided with tiny perforations 7 that are sized to allow the aromatic sawdust particles 5 to be dispensed from the container and cover an area in need of being protected from insects.

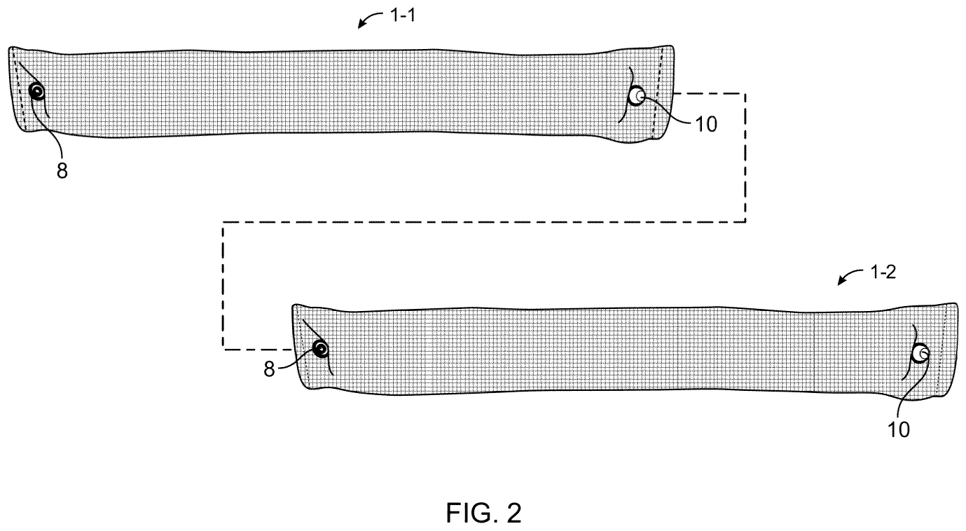

A conventional male snap 8 is attached to one end of the container 1 and a conventional female snap receptacle 10 is attached to the opposite end. As is shown in FIG. 2 of the drawings, a pair of the containers 1-1 and 1-2 in which the insect repellant is carried can be detachably connected end-to-end and joined to one another so as to form a flexible chain having a series of links that are sized to cover an area at which insects are to be repelled. That is, by attaching the male snap 8 from a first container 1-1 to the opposing female snap receptacle 10 of an adjacent container 1-2, the pair of containers are linked one to the other. Although a pair of containers 1-1 and 1-2 are shown connected together, any number of containers may be connected end-to-end and one to the other to form the chain depending upon the size of the area to be protected.

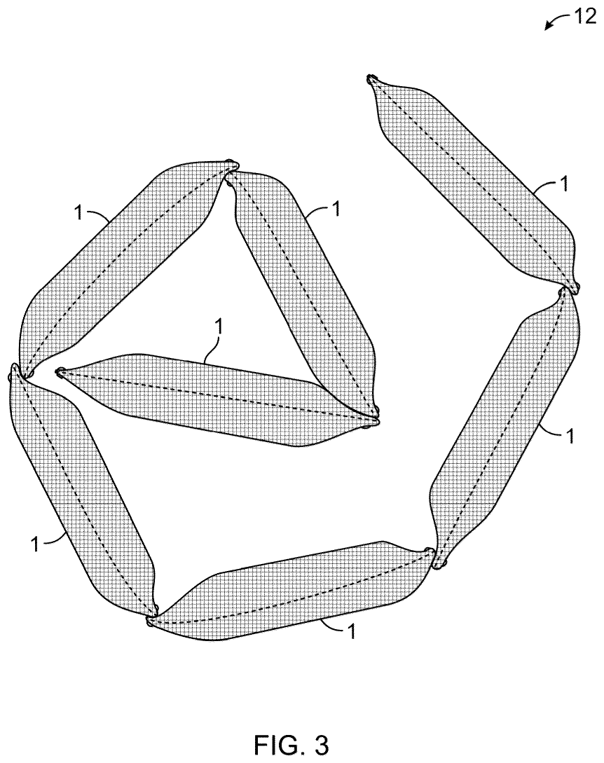

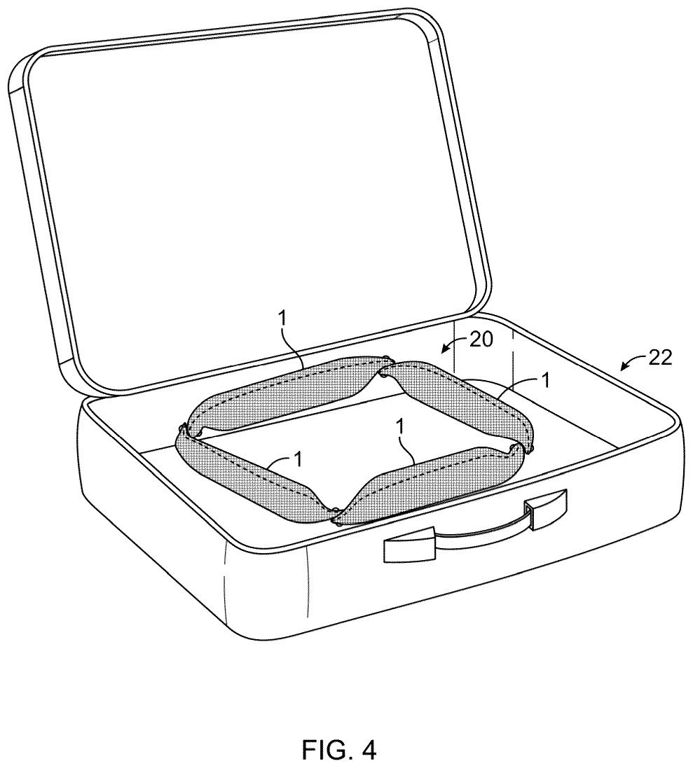

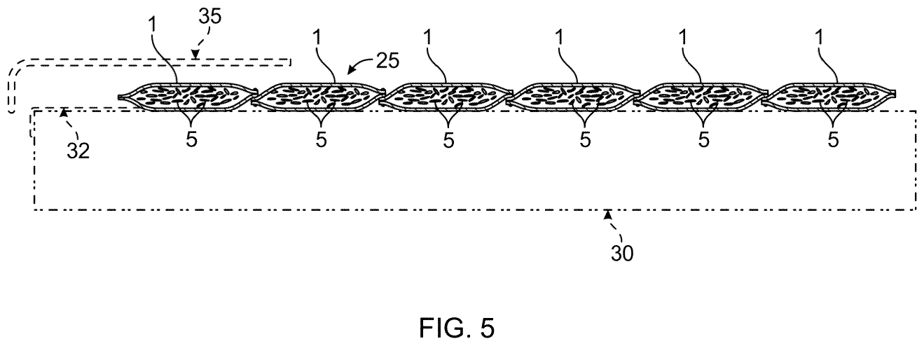

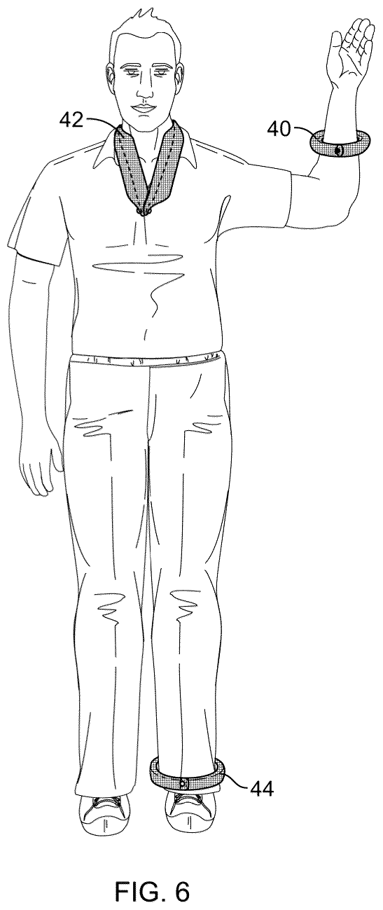

The flexible chain formed by linking the insect repelling containers 1 together can be stretched out or folded depending upon the area to be protected from insects. In this regard, FIG. 3 of the drawings shows a chain 12 that has been formed from a plurality of containers 1 and rolled up upon itself into a ball. FIG. 4 of the drawings shows one example of using the flexible chain 20 of end-to-end connected insect repelling containers 1 after being folded into a configuration that is suitable to fit into a suitcase 15 or a similar travel bag in which clothing is stored or transported. In the case of FIG. 5, the flexible chain 25 formed by linking the plurality of insect repelling containers 1 together is shown stretched out for use in combination with a bed 30. In this example, either a single chain or multiple chains may be located between a bed sheet 32 and a bed cover 35 that is initially laid over the bed sheet 32. One or more flexible chains may also be located inside or around a sleeping bag (not shown) out of doors. In FIG. 6, either a single insect repelling container (designated 1 in FIG. 1) or a series of chains 40, 42 and 44 having different lengths are formed to be wrapped tightly around an individual's arm, neck and/or ankle to offer protection when the individual will spend time out of doors in an insect infested area.

In any event, the aromatic sawdust particles (designated S in FIG. 1) that are dispensed through the perforations 7 when a single one or a plurality of the flexible containers are shaken or compressed leave a deposit, without the use of potentially hazardous chemicals, to repel insects including, but not limited to, flying insects, such as mosquitos, and crawling insects, such as bed bugs.

1. A combination comprising:
a container having a plurality of perforations formed therein; and
aromatic particles which emit an aroma that is capable of repelling insects, said aromatic particles being carried within said container and being sized to be dispensed from the container through the perforations thereof in response to the container being shaken or squeezed.

2. The combination recited in claim 1, wherein said container is flexible and capable of being compressed in response to a squeezing force applied thereto.

3. The combination recited in claim 1, wherein said aromatic particles are made from wood.

4. The combination recited in claim 3, wherein said aromatic wood particles are cedar.

5. The combination recited in claim 3, wherein said aromatic wood particles are sawdust.

6. A combination comprising:
a plurality of flexible containers, each of which having perforations formed therein, said plurality of flexible containers being linked end-to-end and joined one to another to form a chain; and
aromatic particles which emit an aroma that is capable of repelling insects, some of said aromatic particles being carried within each of said plurality of flexible containers, said aromatic particles being sized to be dispensed from said plurality of flexible containers through the perforations thereof in response to said plurality of flexible containers being shaken or squeezed.

7. The combination recited in claim 6, wherein said aromatic particles are sawdust made from cedar wood.

8. The combination recited in claim 6, wherein each of said plurality of flexible containers has a first end and an opposite end and a male snap located at said first end and a female snap receptacle located at said opposite end, the male snap of a first of said plurality of flexible containers being detachably connected to the female snap receptacle of a second of said plurality of flexible containers.

9. The combination recited in claim 6, wherein the chain formed by said plurality of flexible containers that are linked end-to-end and joined one to another is capable of being folded.

10. The combination recited in claim 6, further comprising a carrying case in which articles are to be transported, the chain formed by said plurality of flexible containers that are linked end-to-end and joined one to another being located within and transported by said carrying case.

11. The combination recited in claim 6, further comprising a bed having a bed sheet and a bed cover to cover the bed sheet, the chain formed by said plurality of flexible containers that are linked end-to-end and joined one to the other being located between said bed sheet and said bed cover.

12. The combination recited in claim 6, wherein the plurality of flexible containers that are linked end-to-end and joined one to the other to form the chain are sized so that the chain can be wrapped around at least one of an arm, the neck, or an ankle of an individual who wears the chain.
